(19) United States
(12) Patent Application Publication
(10) Pub. No.: US 2014/0137019 A1
(43) Pub. Date: May 15, 2014

(54) OBJECT CONNECTION

(71) Applicant: APPLE INC., Cupertino, CA (US)

(72) Inventors: Andrew Paulsen, San Jose, CA (US); Heather L. Winkle, Cupertino, CA (US)

(73) Assignee: APPLE INC., Cupertino, CA (US)

(21) Appl. No.: 13/677,207

(22) Filed: Nov. 14, 2012

(51) Int. Cl. G06F 3/048

(52) U.S. Cl. 715/769

(57) ABSTRACT

Methods, program products, and systems for object connection are described. A first user interface item representing a first data object can be visually connected to a second user interface item representing a second data object. Once connected, a connection line representing the connection can be displayed. Moving the first connected user interface item can cause the second connected user interface item to move in synchronization with the first user interface item. During movement of the user interface items, relative positions of the user interface items can remain unchanged.

### TECHNICAL FIELD

This disclosure relates generally to user interfaces of computer programs.

### BACKGROUND

A modern database tool can integrate a database engine with a graphical user interface (GUI). Content of the database can be formatted and displayed in the GUI in a variety of ways according to a design of a builder of the database. The content in the database can include multiple data record. Each data record can be related to an entity or event, including, for example, an activity, an individual, a subject, or a transaction. The data record can include a set of data fields. Each data field can be a unit of data, and can have a field name. In the GUI, a user interface item can correspond to a data field. The user interface item can be associated with a label. The label can correspond to the field name. In a conventional GUI, at design time, the label and the display field can be positioned independently. For example, a designer can place the user interface item in the GUI first, and then add a label. The designer can move the user interface item by drag and drop. The designer can move the label after moving the user interface item.

### SUMMARY

Methods, program products, and systems for object connection are described. A first user interface item representing a first data object can be visually connected to a second user interface item representing a second data object. Once connected, a connection line linking the two user interface items and representing the connection can be displayed. Moving the first connected user interface item can cause the second connected user interface item to move in synchronization with the first user interface item. During movement of the user interface items, relative positions of the user interface items can remain unchanged.

Object connection can be implemented to achieve the following advantages. A system implementing object connection can preserve a portion of the user interface where objects have already arranged when a designer moves the entire portion around. Accordingly, compared to a conventional system where objects move independently of one another, the system described in this specification can provide a more efficient editing tool to a designer. A system implementing object connection can create a master-slave relationship between objects, where movement of a first object controls movement of a second object, but movement of the second object does not control movement of the first object. Accordingly, compared to a conventional system where objects are simply grouped together, the system described in this specification can provide more flexibility.

The details of one or more implementations of object connection are set forth in the accompanying drawings and the description below. Other features, aspects, and advantages of object connection will become apparent from the description, the drawings, and the claims.

### BRIEF DESCRIPTION OF THE DRAWINGS

FIG. 1 illustrates an exemplary user interface for object connection.

FIGS. 2A-2F illustrate exemplary user interface items for creating object connection.

FIG. 3 illustrates exemplary property propagation triggered by object connection creation.

FIG. 4 is a block diagram illustrating exemplary components for creating and maintaining object connection.

FIG. 5 is a flowchart of an exemplary procedure of object connection.

FIG. 6 is a block diagram of an exemplary system architecture for implementing the features and operations of FIGS. 1-5.

Like reference symbols in the various drawings indicate like elements.

### DETAILED DESCRIPTION

### Overview

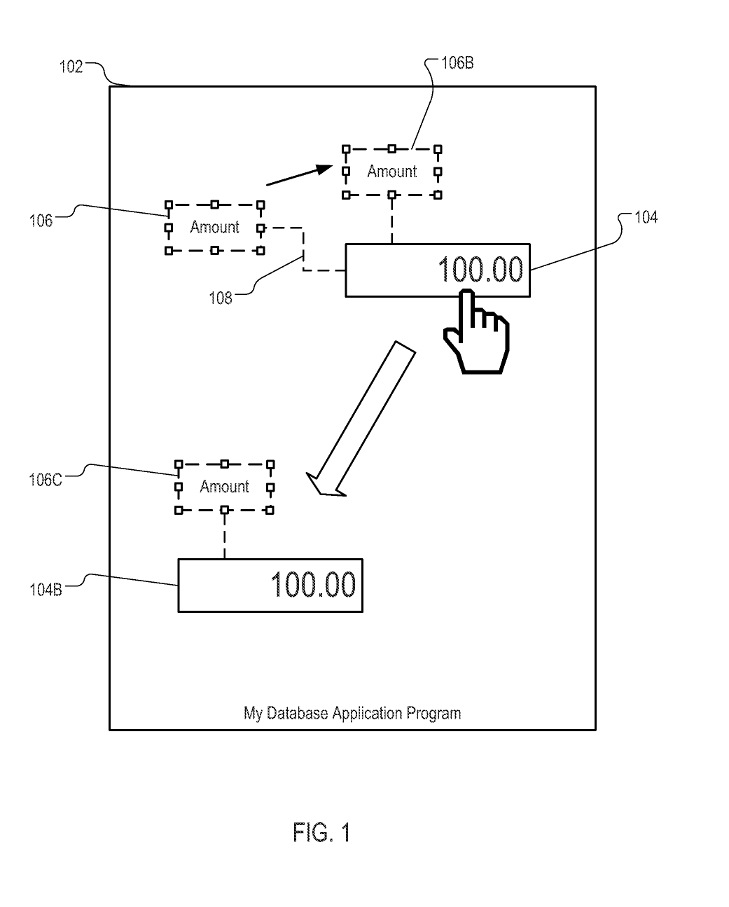

FIG. 1 illustrates an exemplary user interface for object connection. User interface 102 is an exemplary graphical user interface of a database-backed application program executing on a computing device. User interface 102 can be a form view for displaying data records of the database on a display device one at a time, a table view for displaying multiple data records in one screen, or a list view for displaying data records as lists of data fields.

User interface 102 can include user interface item 104 and user interface item 106. User interface item 104 can correspond to a first data object, which can include content of the data field in a data record. User interface item 106 can correspond to a second data object, which can include a name or label of the data field.

User interface item 104 and user interface item 106 can be connected in response to a user input. After user interface item 104 and user interface item 106 are connected, user interface item 104 and user interface item 106 can move together. The relative position of user interface item 104 to user interface item 106 will be maintained during the move. Connection line 108 linking user interface item 104 and user interface item 106 can indicate that underlying data objects of user interface item 104 to user interface item 106 are connected.

When user interface item 104 and user interface item 106 are connected, one of the user interface items can be designated as a master, and the other one a slave. In the example shown, user interface item 104 is the master, user interface item 106 the slave. When the computing device receives an input moving user interface item 104 the master, user interface item 106 the slave moves with user interface item 104 and maintains a relative position to user interface item 104. When the computing device receives an input moving user interface item 106 the slave, user interface item 106 moves in response to the input while user interface item 104 the master remains at an original location. For example, user interface item 106 can receive a drag and drop input moving user interface item 106 to a location labeled in FIG. 1 as 106B. The position of user interface item 106 relative to user interface item 104 can then change, from being at left of user interface item 104 to above user interface item 104.

User interface item 104 the master can receive an input moving user interface item 104 to a position labeled as 104B. During and after the move, user interface item 106 the slave can maintain a position relative to user interface item 104, e.g., by moving to a position labeled as 106C. Because user interface item 104 and user interface item 106 can move in synchronization, a designer of user interface 102 need not rearrange the relative positions of user interface item 104 and user interface item 106 after moving user interface item 104 from one location of user interface 102 to another location of user interface 102.

Additional user interface items can be added to create a stacked hierarchy of master-slave relationships. For example, a second level slave can be added from user interface item 106. User interface item 106 can be a slave for user interface item 104 and a master of the second level slave at the same time. When user interface item 106 receives an input moving user interface item 106, the second level slave can move in synchronization with user interface item 106 while user interface item 104 can remain immobile.

### Creating Object Connection

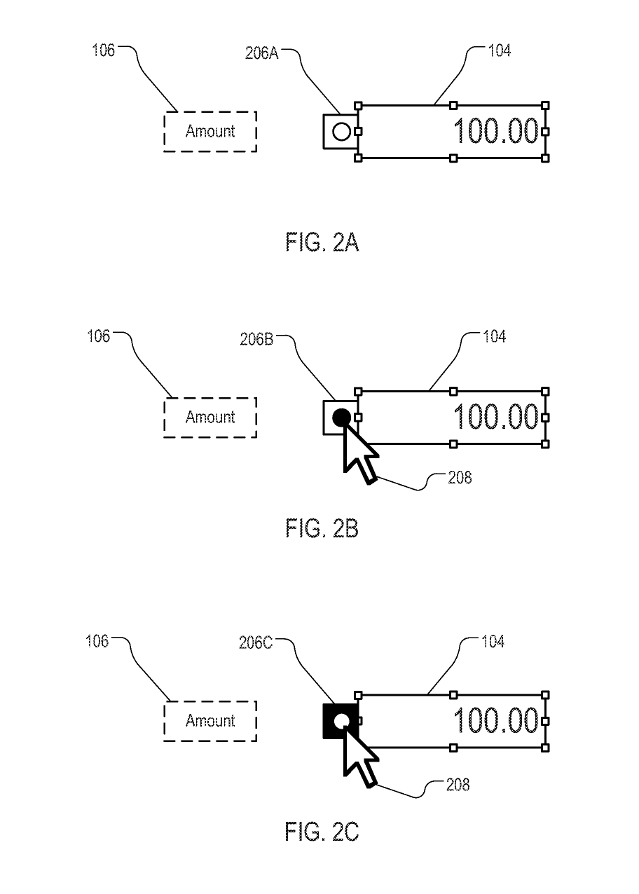

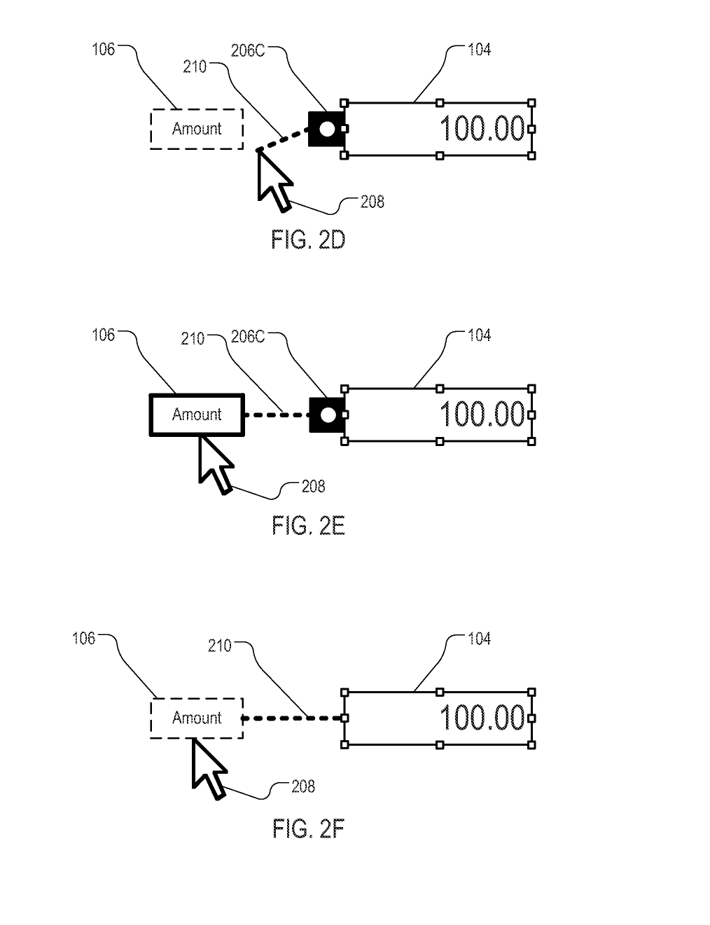

FIGS. 2A-2F illustrate exemplary user interface items for creating object connection. FIG. 2A illustrates a portion of an exemplary user interface of a system (e.g., a computing device) implementing object connection. The portion of the user interface can include user interface item 104 and user interface item 106 of FIG. 1. In the example shown, user interface item 104 can be a data field; user interface item 106 can be a field name (e.g., a column name in a database table) or label (e.g., a user created text boilerplate) of the data field.

User interface item 104 can receive a selection input. The selection input can be a mouse click, a touch input by a finger or a stylus, or a voice input. In response to the selection input, the system can provide for display object connection widget 206A. Object connection widget 206A can include a user interface item displayed next to user interface item 104. Object connection widget 206A can be configured to receive a user input for creating, modify, or deleting connection between user interface item 104 and another user interface item.

FIG. 2B illustrates the portion of the exemplary user interface after the system receives a tentative selection input through object connection widget 206A of FIG. 2A. The tentative selection input can include cursor 208 hovering over object connection widget 206A. When the system detects the tentative selection input, the system can provide for display emphasized object connection widget 206B. Emphasized object connection widget 206B can be an object connection widget highlighted or otherwise emphasized to display prominently.

FIG. 2C illustrates the portion of the exemplary user interface after the system receives an activation input. The system can receive the activation input through object connection widget 206A of FIG. 2A or emphasized object connection widget 206B of FIG. 2B. The activation input can include a finger or stylus touching object connection widget 206A, or cursor 208 clicking on and holding emphasized object connection widget 206B. The system can specify that, to qualify form an activation input, a temporal length of the touch or the hold shall last at least a hold threshold time (e.g., X seconds). When the system detects the activation input, the system can provide for display activated object connection widget 206C. Activated object connection widget 206C can be an object connection widget further highlighted or otherwise emphasized to display prominently, and operable to receive a drag input for connecting user interface item 104 with another user interface item, e.g., user interface item 106.

FIG. 2D illustrates the portion of the exemplary user interface after the system receives a drag input. The system can receive the drag input though activated object connection widget 206C. In some implementations, the drag input can include cursor 208, while being hold on activated object connection widget 206C, dragging activated object connection widget 206C away from user interface item 104. In some implementations, the drag input can include a finger or stylus, while touching activated object connection widget 206C, dragging activated object connection widget 206C away from user interface item 104.

The system can provide for display connection line 210. Connection line 210 can connect an original location of activated object connection widget 206C to a current location of cursor 208, the finger, or the stylus. While cursor 208, the finger, or the stylus moves, connection line 210 can be animated to follow movement of cursor 208, the finger, or the stylus. In some implementations, activated object connection widget 206C can move with cursor 208, the finger, or the stylus during the animation. In some implementations, activated object connection widget 206C can remain anchored to user interface item 104 during the animation. One end of connection line 210 can be attached to activated object connection widget 206C, while another end of animated connection line 210 can move with cursor 208, the finger, or the stylus during the animation.

FIG. 2E illustrates the portion of the exemplary user interface when the drag input described in reference to FIG. 2D drags over user interface item 106. The system can determine that cursor 208, the finger, or the stylus reached user interface item 106. In response, the system can emphasize user interface item 106, e.g., by providing for display a frame for user interface item 106, indicating that if the system receives a connection input, the system can create a connection between user interface item 104 and user interface item 106.

FIG. 2F illustrates the portion of the exemplary user interface where a connection is created between user interface item 104 and user interface item 106. The system can receive a connection input. The connection input can include a drop input when cursor 208 is touching user interface item 106. The drop input can include a mouse release or lifting of finger or stylus off a touch sensitive display device. Upon receiving the connection input, the system can create the connection. When the connection is created, the system can remove activated object connection widget 206C from display. The system can redact connection line 210 such that connection line 210 connects an anchor point on user interface item 104 and an anchor point on user interface item 106. The anchor point on each user interface item can be a user selectable point, or a point that is closest to the other user interface item.

In the example shown, user interface item 104, which was first selected for creating a connection, was a master of the connection. In some implementations, a first selected user interface item can be the master. In some implementations, the system can determine a master-slave relationship based on relationship of data objects underlying the user interface items. For example, the system can determine that a data field is the master, and a name or label of the data field is a slave. In some implementations, the system can determine the master-slave relationship based on user input. After the connection is created, the system can receive a user input, e.g., a drag and drop input, moving a slave, for example, user interface item 106. Upon receiving such an input, the system can keep the master, for example, user interface item 106 unmoved, and move the slave based on where the slave is dropped. When the input changes the relative position of the user interface items, connection line 210 can be animated to move with movement of the slave.

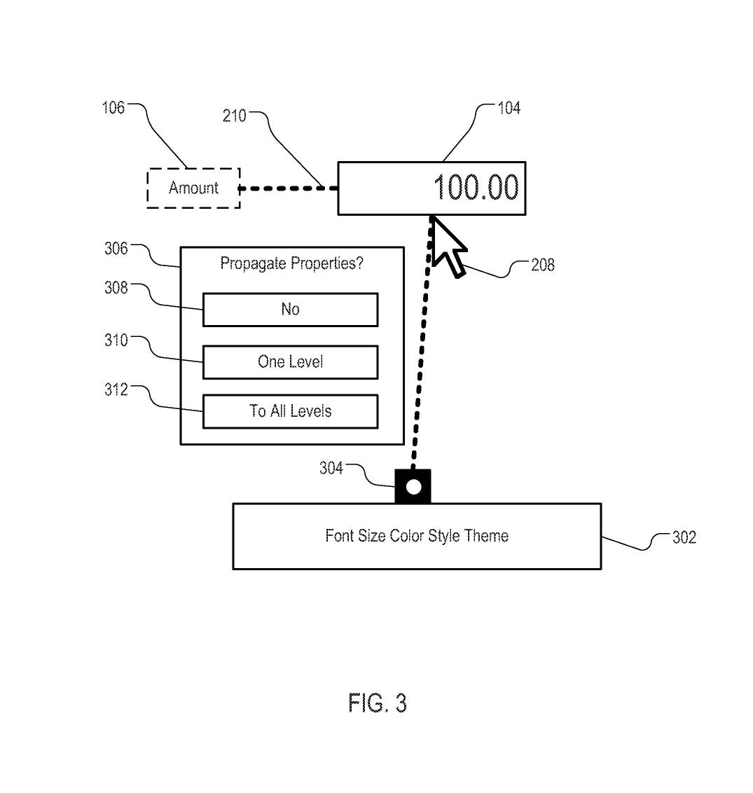

FIG. 3 illustrates exemplary property propagation triggered by object connection creation. The system can receive a connection input for connecting user interface item 302 to user interface item 104, which has already been connected to user interface item 106. The connection input can be received through object connection widget 304. In the example shown, user interface item 106 is a slave of user interface item 104.

When the system receives the connection input (e.g., a drop input), the system can create the connection between user interface item 104 and user interface item 302, in which user interface item 302 is the master and user interface item 104 is the slave. Creation of the connection can trigger a property of a master to propagate from a master through a hierarchy between masters and slaves to a slave. The property can be a formatting property including, for example, at least one of a language setting, a font name, a font style, a font size, a foreground color, a background color, a line color, a color theme, a line dash, a line arrow, or whether a corner of a box is rounded.

Upon creating the connection, the system can provide for display menu 306 for configuring the propagation of the property. Menu 306 can include menu option 308, which, when selected, can cause the system not to propagate the property. Menu 306 can include menu option 310, which, when selected, can cause the system to propagate the property one level down from a master to a slave, e.g., from user interface item 302 to user interface item 104. Menu 306 can include menu option 312, which, when selected, can cause the system to propagate property multiple levels from a master to a slave, e.g., from user interface item 302 to user interface item 104 and then to user interface item 106. In some implementations, the system can have a user-specified default property propagation scheme specifying whether properties shall be propagated and if yes, how many levels. Creation of a connection can automatically trigger the property to be propagated according to the scheme.

After a property is set to propagate from a master to a slave upon creating of a connection between the master and the slave, a subsequent change of the property of the master can cause the property to change at the slave. For example, when property propagation is set to be “to all levels” upon creation of the connection between user interface item 302 and user interface item 104, a change of the property (e.g., a language setting from “US English” to “UK English”) at user interface item 302 after the connection has been created can cause a corresponding property to change for user interface item 104 and user interface item 106. In some implementations, the number of levels of propagation can be user-configurable. In this example, after the changing of language setting at user interface item 302, language settings for both user interface item 104 and user interface item 106 can be changed from “US English” to “UK English.” Conversely, a change of a property at a slave does not affect the corresponding property at a master. For example, after the connections have been created, when the language setting of user interface item 104 is changed from “UK English” to “Arabic,” the language setting of user interface item 106 (the slave) will change accordingly to “Arabic,” while language setting of user interface item 302 (the master) will be unaffected.

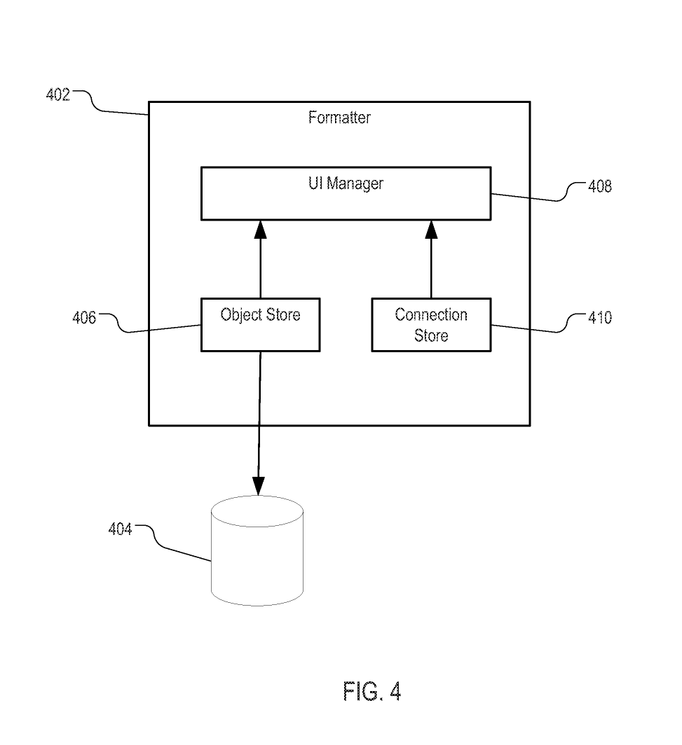

FIG. 4 is a block diagram illustrating exemplary components for creating and maintaining object connection. A system implementing object connection can include formatter 402. Formatter 402 can include hardware and software components configured to perform the operations of connecting to database 404, retrieving data from database 404, and formatting and presenting the retrieved data. Database 404 can be a relational, object oriented, or ad hoc database hosted local to or remote from the system.

Formatter 402 can include object store 406. Object store 406 can be configured to create and maintain data objects. Each data object can correspond to a data record, a data field, or a field name or label of database 404. Formatter 402 can include user interface manager 408. User interface manager 408 can be configured to create and maintain a user interface and user interface items in the user interface. Each user interface item can correspond to a data object. User interface manager 408 can be configured to provide for display and to manage the user interface items and connection widget as described above in reference to FIGS. 1 and 2A-2F. User interface manager 408 can interact with connection store 410. Connection store 410 can be configured to create and store connections between user interface items as connections between underlying data objects. Each time user interface manager 408 receives an input to create, change, or delete a connection between two or more user interface items, connection store 410 can create, change, or delete the corresponding connection between data objects underlying the user interface items.

### Exemplary Procedures

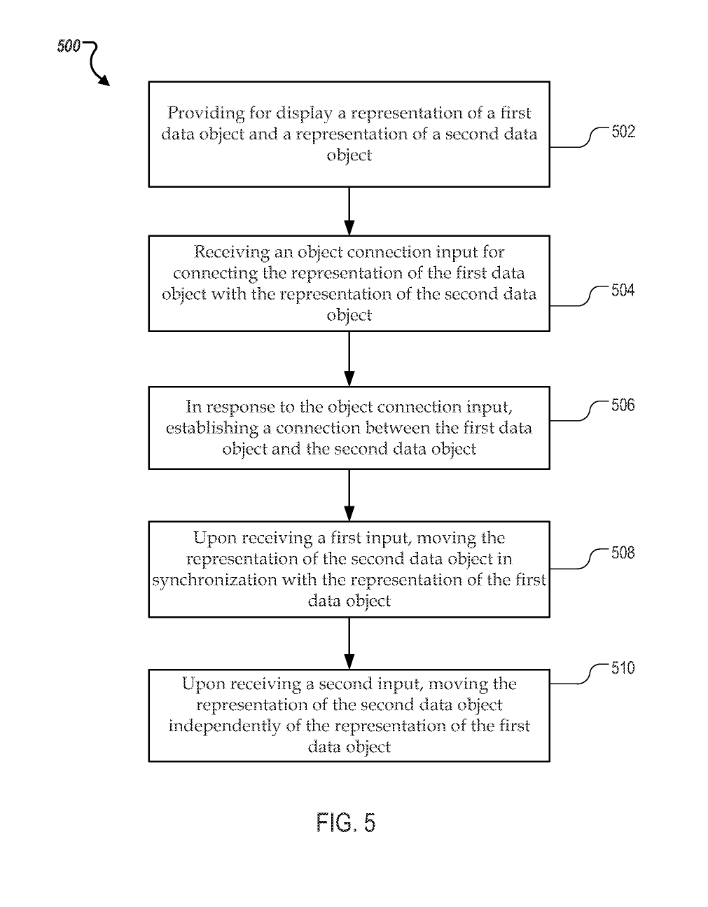

FIG. 5 is a flowchart of exemplary procedure 500 of object connection. A system implementing object connection can provide (502) for display a representation of a first data object (e.g., user interface item 104 of FIGS. 1 and 2A-2F) and a representation of a second data object (e.g., user interface item 106 of FIGS. 1 and 2A-2F). In some implementations, the second data object can include a label of the first data object.

The system can receive (504) an object connection input for connecting the representation of the first data object with the representation of the second data object.

In response to the object connection input, the system can establish (506) a connection between the first data object and the second data object. In some implementations, upon establishing the connection between the first data object and the second data object, the system can emphasize the representation of the second data object using a border, a highlight, or a font. The system can provide for display a connection line connecting the representation of the first data object and the representation of the second data object. In some implementations, establishing the connection between the first data object and the second data object can trigger a property of the first data object to be applied to the second data object. The property can be a formatting property.

Upon receiving a first input moving the representation of the first data object (which can be a master as designated in the connection), the system can move (508) the representation of the second data object in synchronization with the representation of the first data object. During the synchronized move, a relative position between the representation of the first data object and the representation of the second data object can be preserved.

1. Upon receiving a second input moving the representation of the second data object (which can be a slave as designated in the connection), the system can move (510) the representation of the second data object independently of the representation of the first data object. During the move, the relative position between the representation of the first data object and the representation of the second data object can be changed. When the representation of the second data object moves independently of the representation of the first data object, the representation of the first data object can remain immobile. Upon receiving a second input moving the representation of the second data object, the system can animate a connection line that connects the moving representation of the second data object and the static representation of the first data object. After the representation of the second data object moved independently of the representation of the first data object, the system can receive a third input moving the representation of the first data object. In response to the third input, the system can move the representation of the first data object in synchronization with the representation of the second data object. The changed relative position between the representation of the first data object and the representation of the second data object can be preserved during and after the move.

In some implementations, the system can provide for display an object connection widget (e.g., object connection widget 206A, 206B, or 206C) in association with the representation of the first data object. The object connection widget can include a rectangle surrounding a circle, the rectangle and circle initially being attached to the representation of the first data object and being detachable from the representation of the first data object when selected.

The object connection widget can include a selectable user interface item having an inactive state when not selected, and an active state when selected. When the object connection widget is in the active state, the object connection widget can be moved according to a drag input and placed on the representation of the second data object according to a drop input. When the object connection widget moves in response to the drag input, the system can provide for display an animated line (e.g., connection line 210) connecting the object connection widget and connecting the representation of the first data object. The object connection input of stage 504 can include the drop input placing the object connection widget on the representation of the second data object.

### Exemplary System Architecture

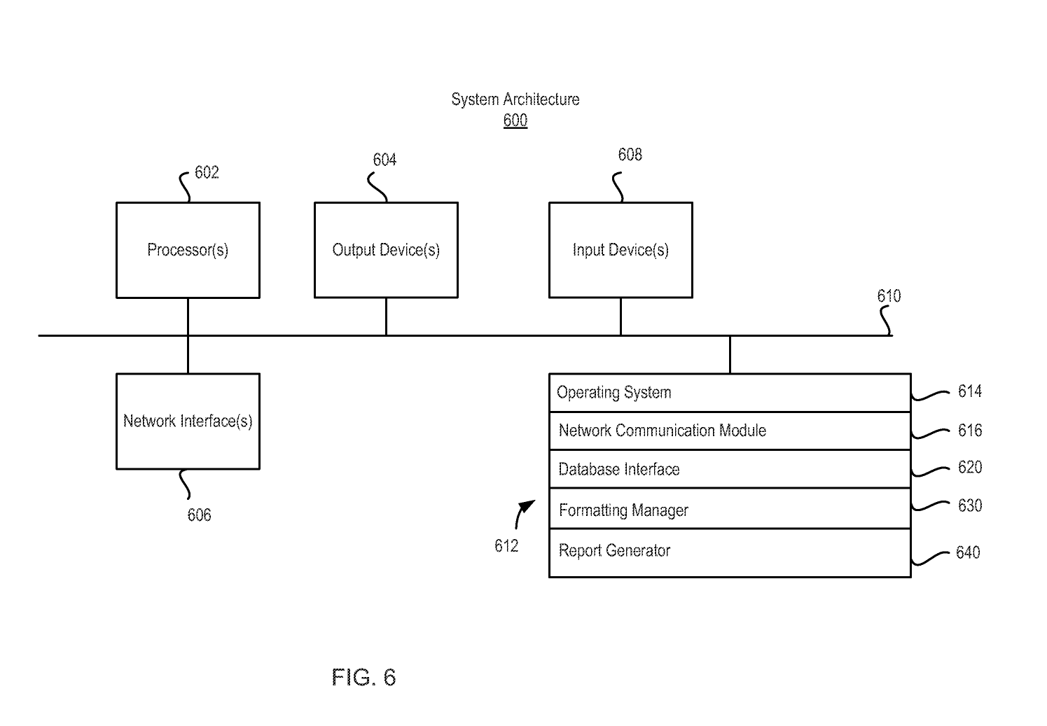

FIG. 6 is a block diagram of an exemplary system architecture for implementing the features and operations of FIGS. 1-4. Other architectures are possible, including architectures with more or fewer components. In some implementations, architecture 600 includes one or more processors 602 (e.g., dual-core Intel® Xeon® Processors), one or more output devices 604 (e.g., LCD), one or more network interfaces 606, one or more input devices 608 (e.g., mouse, keyboard, touch-sensitive display) and one or more computer-readable mediums 612 (e.g., RAM, ROM, SDRAM, hard disk, optical disk, flash memory, etc.). These components can exchange communications and data over one or more communication channels 610 (e.g., buses), which can utilize various hardware and software for facilitating the transfer of data and control signals between components.

The term “computer-readable medium” refers to a medium that participates in providing instructions to processor 602 for execution, including without limitation, non-volatile media (e.g., optical or magnetic disks), volatile media (e.g., memory) and transmission media. Transmission media includes, without limitation, coaxial cables, copper wire and fiber optics.

Computer-readable medium 612 can further include operating system 614 (e.g., a Linux® operating system), network communication module 616, database interface 620, formatting manager 630, and report generator 640. Operating system 614 can be multi-user, multiprocessing, multitasking, multithreading, real time, etc. Operating system 614 performs basic tasks, including but not limited to: recognizing input from and providing output to devices 606, 608; keeping track and managing files and directories on computer-readable mediums 612 (e.g., memory or a storage device); controlling peripheral devices; and managing traffic on the one or more communication channels 610. Network communications module 616 includes various components for establishing and maintaining network connections (e.g., software for implementing communication protocols, such as TCP/IP, HTTP, etc.).

Database interface 620 can include computer instructions that, when executed, cause processor 602 to connect to a local or remote database and to maintain the connection. Formatting manager 630 can include computer instructions that, when executed, cause processor 602 to perform operations described above in reference to formatter 402 of FIG. 4. Report generator 640 can include computer instructions that, when executed, cause processor 602 to provide for display a user interface of a database application program where data objects are arranged using the object connection techniques.

Architecture 600 can be implemented in a parallel processing or peer-to-peer infrastructure or on a single device with one or more processors. Software can include multiple software components or can be a single body of code.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, a browser-based web application, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor or a retina display device for displaying information to the user. The computer can have a touch surface input device (e.g., a touch screen) or a keyboard and a pointing device such as a mouse or a trackball by which the user can provide input to the computer. The computer can have a voice input device for receiving voice commands from the user.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

A number of implementations of the invention have been described. Nevertheless, it will be understood that various modifications can be made without departing from the spirit and scope of the invention.

What is claimed is:

1. A method comprising:
providing for display a representation of a first data object and a representation of a second data object;
receiving an object connection input for connecting the representation of the first data object with the representation of the second data object; and
in response to the object connection input, establishing a connection between the first data object and the second data object, wherein:
upon receiving a first input moving the representation of the first data object, the representation of the second data object moves in synchronization with the representation of the first data object, wherein a relative position between the representation of the first data object and the representation of the second data object is preserved; and
upon receiving a second input moving the representation of the second data object, the representation of the second data object moves independently of the representation of the first data object, wherein the relative position between the representation of the first data object and the representation of the second data object is changed.

2. The method of claim 1, comprising providing for display an object connection widget in association with the representation of the first data object, the object connection widget comprising a selectable user interface item having an inactive state when not selected, and an active state when selected.

3. The method of claim 2, wherein the user interface item comprises a rectangle surrounding a circle, the rectangle and circle initially being attached to the representation of the first data object and being detachable from the representation of the first data object when selected.

4. The method of claim 2, wherein:
when the user interface item is in the active state, the object connection widget is operable to be moved according to a drag input and placed on the representation of the second data object according to a drop input, and
when the object connection widget moves in response to the drag input, an animated line connects the object connection widget and connecting the representation of the first data object.

5. The method of claim 4, wherein the object connection input includes the drop input placing the object connection widget on the representation of the second data object.

6. The method of claim 1, wherein the second data object comprises a label of the first data object.

7. The method of claim 1, comprising:
upon establishing the connection between the first data object and the second data object:
emphasizing the representation of the second data object using a border, a highlight, or a font; and
providing for display a connection line connecting the representation of the first data object and the representation of the second data object.

8. The method of claim 1, comprising:
upon receiving a second input moving the representation of the second data object, animating a connection line wherein the animated connection line connects a moving representation of the second data object and a static representation of the first data object.

9. The method of claim 1, wherein when the representation of the second data object moves independently of the representation of the first data object, the representation of the first data object remains immobile.

10. The method of claim 9, comprising:
after the representation of the second data object moved independently of the representation of the first data object, receiving a third input moving the representation of the first data object; and
in response to the third input, moving the representation of the first data object in synchronization with the representation of the second data object, wherein the changed relative position between the representation of the first data object and the representation of the second data object is preserved.

11. The method of claim 1, wherein establishing the connection between the first data object and the second data object triggers a property of the first data object to be applied to the second data object.

12. A non-transitory storage device storing instructions operable to cause one or more computers to perform operations comprising:
providing for display a representation of a first data object and a representation of a second data object;
receiving an object connection input for connecting the representation of the first data object with the representation of the second data object; and
in response to the object connection input, establishing a connection between the first data object and the second data object, wherein:
upon receiving a first input moving the representation of the first data object, the representation of the second data object moves in synchronization with the representation of the first data object, wherein a relative position between the representation of the first data object and the representation of the second data object is preserved; and
upon receiving a second input moving the representation of the second data object, the representation of the second data object moves independently of the representation of the first data object, wherein the relative position between the representation of the first data object and the representation of the second data object is changed.

13. The non-transitory storage device of claim 12, comprising providing for display an object connection widget in association with the representation of the first data object, the object connection widget comprising a selectable user interface item having an inactive state when not selected, and an active state when selected.

14. The non-transitory storage device of claim 13, wherein the user interface item comprises a rectangle surrounding a circle, the rectangle and circle initially being attached to the representation of the first data object and being detachable from the representation of the first data object when selected.

15. The non-transitory storage device of claim 13, wherein:
when the user interface item is in the active state, the object connection widget is operable to be moved according to a drag input and placed on the representation of the second data object according to a drop input, and
when the object connection widget moves in response to the drag input, an animated line connects the object connection widget and connecting the representation of the first data object.

16. The non-transitory storage device of claim 15, wherein the object connection input includes the drop input placing the object connection widget on the representation of the second data object.

17. The non-transitory storage device of claim 12, wherein the second data object comprises a label of the first data object.

18. The non-transitory storage device of claim 12, the operations comprising:
upon establishing the connection between the first data object and the second data object:
emphasizing the representation of the second data object using a border, a highlight, or a font; and
providing for display a connection line connecting the representation of the first data object and the representation of the second data object.

19. The non-transitory storage device of claim 12, the operations comprising:
upon receiving a second input moving the representation of the second data object, animating a connection line wherein the animated connection line connects a moving representation of the second data object and a static representation of the first data object.

20. The non-transitory storage device of claim 12, wherein when the representation of the second data object moves independently of the representation of the first data object, the representation of the first data object remains immobile.

21. The non-transitory storage device of claim 20, the operations comprising:
after the representation of the second data object moved independently of the representation of the first data object, receiving a third input moving the representation of the first data object; and
in response to the third input, moving the representation of the first data object in synchronization with the representation of the second data object, wherein the changed relative position between the representation of the first data object and the representation of the second data object is preserved.

22. The non-transitory storage device of claim 12, wherein establishing the connection between the first data object and the second data object triggers a property of the first data object to be applied to the second data object.

23. A system comprising:
one or more computers;
a non-transitory storage device storing instructions operable to cause the one or more computers to perform operations comprising:
providing for display a representation of a first data object and a representation of a second data object;
receiving an object connection input for connecting the representation of the first data object with the representation of the second data object; and
in response to the object connection input, establishing a connection between the first data object and the second data object, wherein:
upon receiving a first input moving the representation of the first data object, the representation of the second data object moves in synchronization with the representation of the first data object, wherein a relative position between the representation of the first data object and the representation of the second data object is preserved; and
upon receiving a second input moving the representation of the second data object, the representation of the second data object moves independently of the representation of the first data object, wherein the relative position between the representation of the first data object and the representation of the second data object is changed.

24. The system of claim 23, comprising providing for display an object connection widget in association with the representation of the first data object, the object connection widget comprising a selectable user interface item having an inactive state when not selected, and an active state when selected.

25. The system of claim 24, wherein the user interface item comprises a rectangle surrounding a circle, the rectangle and circle initially being attached to the representation of the first data object and being detachable from the representation of the first data object when selected.

26. The system of claim 24, wherein:
when the user interface item is in the active state, the object connection widget is operable to be moved according to a drag input and placed on the representation of the second data object according to a drop input, and
when the object connection widget moves in response to the drag input, an animated line connects the object connection widget and connecting the representation of the first data object.

27. The system of claim 26, wherein the object connection input includes the drop input placing the object connection widget on the representation of the second data object.

28. The system of claim 24, wherein the second data object comprises a label of the first data object.

29. The system of claim 23, the operations comprising:
upon establishing the connection between the first data object and the second data object:
emphasizing the representation of the second data object using a border, a highlight, or a font; and
providing for display a connection line connecting the representation of the first data object and the representation of the second data object.

30. The system of claim 23, the operations comprising:
upon receiving a second input moving the representation of the second data object, animating a connection line wherein the animated connection line connects a moving representation of the second data object and a static representation of the first data object.

31. The system of claim 23, wherein when the representation of the second data object moves independently of the representation of the first data object, the representation of the first data object remains immobile.

32. The system of claim 31, the operations comprising:
after the representation of the second data object moved independently of the representation of the first data object, receiving a third input moving the representation of the first data object; and
in response to the third input, moving the representation of the first data object in synchronization with the representation of the second data object, wherein the changed relative position between the representation of the first data object and the representation of the second data object is preserved.

33. The system of claim 23, wherein establishing the connection between the first data object and the second data object triggers a property of the first data object to be applied to the second data object.
